(19) United States
(12) Patent Application Publication
(10) Pub. No.: US 2002/0030430 A1
(43) Pub. Date: Mar. 14, 2002

(54) Color cathode ray tube having plural electrostatic quadrupole lenses

(76) Inventors: Kouichi Miyagawa, Mobara (JP); Shinichi Katou, Mobara (JP); Kazunari Noguchi, Chiba (JP); Gou Uchida, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/912,326

(22) Filed: Jul. 26, 2001

(30) Foreign Application Priority Data
Sep. 8, 2000 (JP) 2000-273513

(51) Int. Cl. H01J 29/50

(52) U.S. Cl. 313/414

(57) ABSTRACT

A color cathode ray tube has a three in-line beam electron gun. The electron gun includes a first group of focus electrodes supplied with a first fixed focus voltage and a second group of focus electrodes supplied with a second focus voltage comprised of a fixed voltage and a dynamic voltage synchronized with beam deflection. Plural axially spaced electrostatic quadrupole lenses are formed between facing ones of the first and second groups of focus electrodes. One of the plural electrostatic quadrupole lenses nearest to the cathodes is configured so as to produce a lens action weaker on two side electron beams than on the center electron beam.

### BACKGROUND OF THE INVENTION

The present invention relates to a cathode ray tube, and in particular to a color cathode ray tube having an in-line type electron gun employing a multistage focus lens for focusing a plurality of electron beams on a phosphor screen.

Shadow mask type color cathode ray tubes are most commonly used as TV picture tubes and monitor tubes for information terminals. The shadow mask type color cathode ray tubes house an electron gun for emitting a plurality (usually three) of electron beams within one end of an evacuated envelope, a phosphor screen formed of phosphors coated on an inner surface of the evacuated envelope at the other end thereof for emitting light of a plurality (usually three) of colors, and a shadow mask which serves as a color selection electrode and is closely spaced from the phosphor screen. The electron beams emitted from the electron gun are deflected to scan the phosphor screen two-dimensionally by magnetic fields generated by a deflection yoke mounted externally of the evacuated envelope and to display a desired image on the phosphor screen.

FIG. 8 is a cross-sectional view of the shadow mask type color cathode ray tube for explaining its structural example, reference numeral 81 denotes a panel portion forming a viewing screen, 82 is a neck portion for housing an electron gun, 83 is a funnel portion for connecting the panel portion 81 and the neck portion 82, 84 is a phosphor screen, 85 is a shadow mask serving as a color selection electrode, 86 is a mask frame for supporting the shadow mask 85, 87 is a magnetic shield for shielding extraneous magnetic fields such as the earth's magnetic field, 88 is a mask suspension mechanism, 89 is an in-line type electron gun, reference character DY denotes a deflection yoke, reference numeral 83a denotes an internal conductive coating, 82a are stem pins, and reference character GA denotes a getter.

In this the color cathode ray tube, the evacuated envelope is comprised of the panel portion 81, the neck portion 82 and the funnel portion 83, and electron beams B (one center electron beam and two side electron beams, only one of which is shown) emitted from the electron gun 89 housed in the neck portion 82 scan the phosphor screen 84 in two dimensions by being subjected to the horizontal and vertical deflection magnetic fields produced by the deflection yoke DY.

The deflection yoke DY is of the self-converging type which provides a pin cushion-like horizontal deflection magnetic field and a barrel-like vertical deflection magnetic field to converge the plural electron beams over the entire phosphor screen.

The electron beams B are modulated in amount by modulating signals such as video signals supplied via the stem pins 82a, are color-selected by the shadow mask 85 disposed immediately in front of the phosphor screen 84, and impinge upon the phosphors of the corresponding colors to reproduce a desired image.

The cathode ray tubes of this kind are provided with a multistage focus lens in the electron gun and a so-called dynamic focusing system is widely adopted where at least one of the electrodes constituting the multistage focus lens is supplied with a voltage varying dynamically, to obtain sufficiently small electron beam spots over the entire phosphor screen.

FIG. 9 is a schematic cross-sectional view of an example of an electrode structure of an in-line type electron gun employed in a color cathode ray tube, taken perpendicular to the in-line direction of three in-line electron beams.

In FIG. 9, reference numeral 91 denote three cathodes each having a heater incorporated therein, 92 is a control electrode, 93 is an accelerating electrode, 95 is a focus electrode of a first group, 94 and 96 are focus electrodes of a second group, 941, 951 and 952, and 961 are protuberant correction plates attached to the focus electrodes 94, 95 and 96, respectively, 96b is a correction plate electrode, 97 is an anode, 97a is an anode-side correction electrode, and 98 is a shield cup.

The focus electrode 95 of the first group is supplied with a fixed focus voltage Vf1, the focus electrodes 94, 96 of the second group are supplied with a fixed voltage Vf2 superposed with a dynamic voltage varying with the amount of deflection of the electron beams, and the anode 97 is supplied with an anode voltage Eb.

In the electron gun of this structure, a second-stage electrostatic quadrupole lens LB is formed between the protuberant correction plates 952 and the protuberant correction plates 961 attached to the focus electrode 95 of the first group and the focus electrode 96 of the second group, respectively, and a first-stage electrostatic quadrupole lens LA for shaping the electron beams is formed between the protuberant correction plates 941 and the protuberant correction plates 951 attached to the focus electrode 94 of the second group and the focus electrode 95 of the first group, respectively. The first-stage electrostatic quadrupole lens LA and the second-stage electrostatic quadrupole lens LB are configured such that the first-stage electrostatic quadrupole lens LA focuses the electron beams in one of the horizontal and vertical directions and diffuses the electron beams in the other of the horizontal and vertical directions, and on the other hand, the second-stage electrostatic quadrupole lens LB diffuses the electron beams in the one of the horizontal and vertical directions and focuses the electron beams in the other of the horizontal and vertical directions. A main lens LM is formed between the focus electrode 96 of the second group and the anode 97.

The thermionic electrons emitted from the heated cathodes 91 are accelerated toward the control electrode 92 by a potential of the accelerating electrode 93 to form three electron beams. After passing through the electron beam apertures 92a in the control electrode 92, the electron beam apertures 93a in the accelerating electrode 93, and the focus electrodes 94-96, the three electron beams are focused on the phosphor screen to form the beam spots by the main lens LM formed between the focus electrode 96 of the second group and the anode 97.

The electron guns used in color cathode ray tubes such as TV picture tubes and display monitor tubes need to provide a good focus over the entire phosphor screen area and high image resolution. Consequently, the electron guns need to control the cross-sectional shape of the electron beams properly according to the amount of electron beam deflection.

With the above-described electron gun, the cross-sectional shape of the electron beams entering the main lens is elongated vertically with the increasing amount of deflection of the electron beams by the astigmatism-correcting electrostatic quadrupole lens LB formed between the focus electrodes 95 and 96. On the other hand, the electron beams are greatly influenced by deflection defocusing which originates in the deflection yoke, compresses the vertical diameter of the cross section of the electron beams, expands the horizontal diameter of the cross section of the electron beams, and thereby elongates the cross section of the electron beams horizontally. Consequently, the electron beam spots are elongated horizontally at the periphery of the viewing screen.

When the electron beam spots on the phosphor screen becomes horizontally elongated, moire occurs easily due to interference between the scanning lines of the electron beams and the arrangement of electron beam aperture in the shadow mask. If moire appears in the viewing screen, it is difficult to obtain good and uniform focus over the entire screen area, and to recognize characters and images displayed on the viewing screen, and consequently, substantial image resolution is degraded.

Therefore it is necessary to control the shape of the electron beam spot with the amount of beam deflection by forming, in addition to the above electrostatic quadrupole lens LB, another electrostatic quadrupole lens LA serving as an electron beam shaping lens between the focus electrodes 94 and 95 in a position nearer to the cathodes 91 than the electrostatic quadrupole lens LB is.

The beam-shaping electrostatic quadrupole lens LA is capable of shaping the electron beam spots with the amount of deflection of the electron beams as desired, and consequently, is capable of canceling elongation of the electron beam spots at the screen periphery caused by the astigmatism-correcting electrostatic quadrupole lens LB. Occurrence of moire is suppressed such that good and uniform focus is obtained over the entire screen. The electron gun employing the above-explained electrostatic quadrupole lenses are disclosed in Japanese Patent Application Laid-open No. Hei 8-31332 (laid-open on Feb. 2, 1996), for example.

### SUMMARY OF THE INVENTION

In the above-described in-line type electron gun, deflection defocusing produced by the self-converging magnetic fields of the deflection yoke makes different changes in cross-sectional shape among a green electron beam (hereinafter the G beam) emitted from a center electron gun, a red electron beam (hereinafter the R beam) emitted from one of the two side electron guns, and a blue electron beam (hereinafter the B beam) emitted from the other of the two side electron guns.

Now consider a case in which the red electron gun is on the right-hand side, the green electron gun is on the tube axis, and the blue electron gun is on the left-hand side as seen from phosphor screen. When the R beam is deflected to the left-hand side of the screen or the B beam is deflected to right-hand side of the screen, the R beam or the B beam is subjected to weaker influence of the deflection defocusing produced by the deflection yoke than the G beam is, and consequently, the beam spot of the R beam or the B beam is horizontally elongated less than the G beam, and therefore the vertical diameter of the R beam at the left-hand side of the screen and that of the B beam at the right-hand side of the screen are larger than the vertical diameter of the G beam.

The current of the R beam is 1.1 to 1.3 times the current of the G beam when a white scene is displayed on the viewing screen. Therefore, when the color temperature is adjusted for the display monitor, the spot diameter of the R beam becomes larger than that of the G beam such that the spot diameter of the R beam is increased further at the left-hand side of the screen. As a result, the R beam at the left-hand side of the screen and the B beam at the right-hand side of the screen are overcompensated to provide vertically elongated beam spots by the beam-shaping electrostatic quadrupole lens LA, the vertical resolution is deteriorated, and this makes it difficult to obtain good and uniform characteristics over the entire screen area, which is one of the problems to be solved.

It is a representative object of the present invention to provide a high-resolution color cathode ray tube by shaping the beam spots into a good shape over a wide area of the viewing screen, and thereby suppressing occurrence of moire.

To achieve the above object, in a representative aspect of the present invention, plural electrostatic quadrupole lenses are disposed in spaced relationship in the in-line type electron gun, and one of the electrostatic quadrupole lens disposed nearest to the cathodes is configured so as to produce a lens action weaker on the two side electron beams of the three electron beams than on the center electron beam of the three electron beams.

In accordance with an embodiment of the present invention, there is provided a color cathode ray tube comprising an evacuated envelope comprising a panel portion, a neck portion and a funnel portion for connecting the panel portion and the neck portion, a phosphor screen formed on an inner surface of the panel portion, an in-line type electron gun housed in the neck portion, and an electron beam deflection yoke mounted around a vicinity of a transitional region between the neck portion and the funnel portion, the in-line type electron gun comprising: an electron beam generating section having three in-line cathodes, a first electrode serving as an electron beam control electrode and a second electrode serving as an accelerating electrode arranged in the order named for projecting three electron beams arranged approximately in parallel with each other in a horizontal plane toward the phosphor screen; a first group of focus electrodes supplied with a first focus voltage of a fixed value; a second group of focus electrodes supplied with a second focus voltage comprised of a fixed voltage and a dynamic voltage varying in synchronism with deflection of the three electron beams; an anode forming a main lens in cooperation with an adjacent one of the second group of focus electrodes; and a plurality of axially spaced electrostatic quadrupole lenses being formed between facing ones of the first and second groups of focus electrodes such that each of the plurality of electrostatic quadrupole lenses increases a lens strength thereof for focusing the three electron beams in one of horizontal and vertical directions, and increases a lens strength thereof for diffusing the three electron beams in another of the horizontal and vertical directions, with an increase in a focus voltage difference between the first focus voltage and the second focus voltage, wherein a first one of the plurality of electrostatic quadrupole lenses nearest to the three in-line cathodes is configured so as to produce a lens action weaker on two side electron beams of the three electron beams than on a center electron beam of the three electron beams.

The present invention is not limited to the above structures or the structures of the embodiments described subsequently, and various changes and modifications may be made without departing from the scope of the invention as defined in the appended claims.

### BRIEF DESCRIPTION OF THE DRAWINGS

In the accompanying drawings, in which like reference numerals designate similar components throughout the figures, and in which:

FIG. 1 is a schematic cross-sectional view of an electron gun for explaining a color cathode ray tube in accordance with an embodiment of the present invention;

FIGS. 2A and 2B are plan views of the focus electrodes of the electron gun of FIG. 1, taken in the directions of the arrows IIA-IIA and IIB-IIB of FIG. 1, respectively;

FIG. 3 is a schematic cross-sectional view of an electron gun for explaining a color cathode ray tube in accordance with another embodiment of the present invention;

FIG. 4 is a perspective view of major portions of the focus electrodes of FIG. 3;

FIG. 5 is a schematic cross-sectional view of an electron gun for explaining a color cathode ray tube in accordance with still another embodiment of the present invention;

FIG. 6 is a perspective view similar to that of FIG. 4, illustrating major portions of focus electrodes for explaining a color cathode ray tube in accordance with still another embodiment of the present invention;

FIG. 7 is a perspective view similar to that of FIG. 4, illustrating major portions of focus electrodes for explaining a color cathode ray tube in accordance with still another embodiment of the present invention;

FIG. 8 is a cross-sectional view of an example of a shadow mask type color cathode ray tube; and

FIG. 9 is a schematic cross-sectional view of an example of an electrode configuration of an in-line type electron gun used in a color cathode ray tube.

### DETAILED DESCRIPTION OF THE PREFERRED EMBODIMENTS

The detailed explanation will be given to the embodiments according to the present invention referring to the drawings.

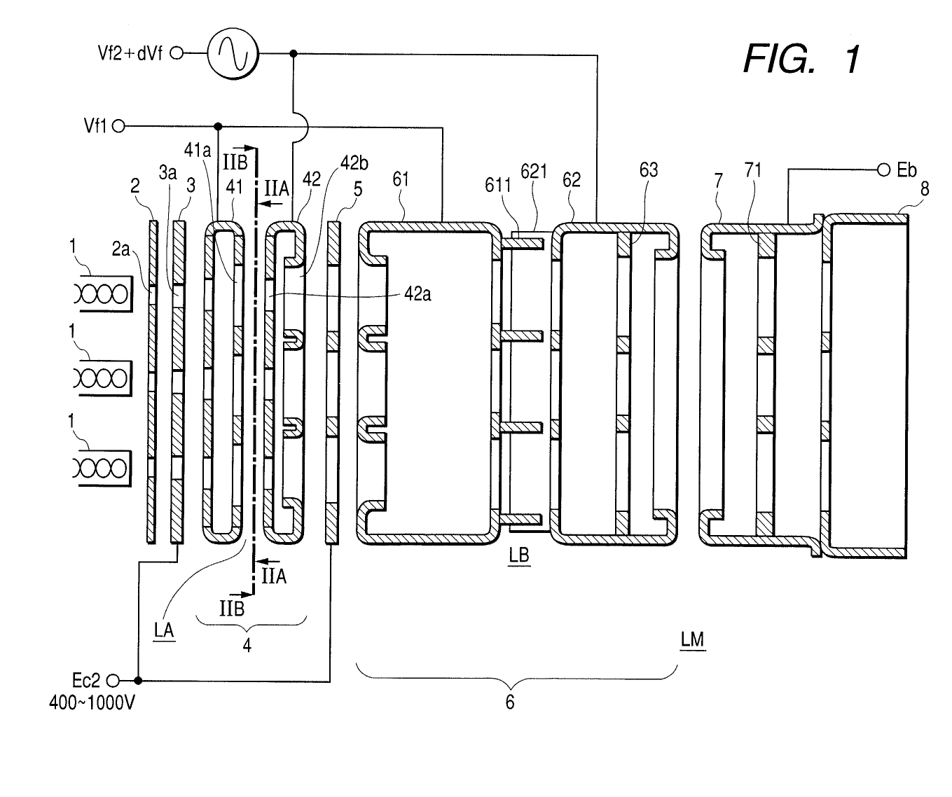

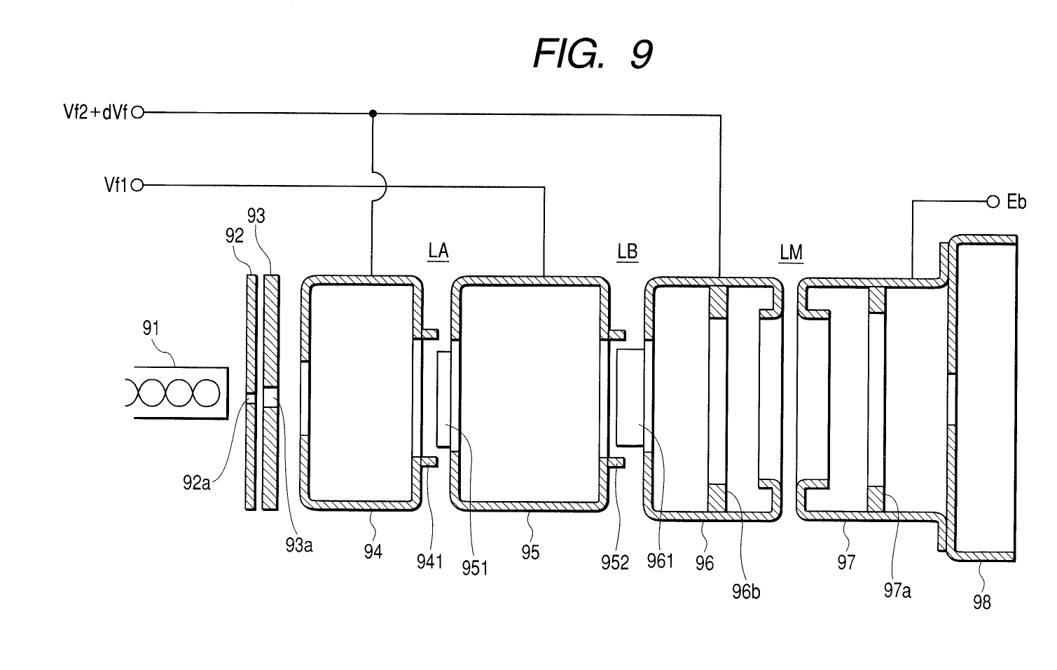

FIG. 1 is a schematic cross-sectional view of an electron gun viewed in a direction perpendicular to the in-line direction of the three in-line electron beams for explaining a first embodiment of a color cathode ray tube according to the present invention. The same reference numerals as utilized in FIG. 9 designate functionally similar portions in FIG. 1.

In this embodiment, an electron beam generating section comprises cathodes 1, a control electrode 2 and an accelerating electrode 3, and an electron beam focusing section comprises a third electrode 41 of a first focus electrode group and a third electrode of a second focus electrode group which constitute a third electrode 4, a fourth electrode 5, a fifth electrode 61 of the first focus electrode group and a fifth electrode 62 of the second focus electrode group which constitute a fifth electrode 6, an anode 7, a shield cup 8, a correction plate electrode 63 disposed within the fifth electrode 62 of the second focus electrode group, and a correction plate electrode 71 disposed within the anode 7. Reference numerals 2a, 3a, 41a, 42a and 42b denote electron beam apertures in the electrodes.

In the above electrode configuration, the accelerating electrode 3 and the fourth electrode 5 are supplied with a fixed voltage Ec2 of about 400V to about 1000V, and the third electrode 41 and the fifth electrode 61 of the first focus electrode group are supplied with a first focus voltage of a fixed value Vf1. The third electrode 42 and the fifth electrode 62 of the second focus electrode group are supplied with a second focus voltage (Vf2+dVf) which is a fixed voltage Vf2 superposed with a dynamic voltage dVf varying with deflection angle of the electron beams scanning the viewing screen. The first focus voltage is the fixed voltage Vf1 in a range of 5 kV to 10 kV, for example, and the second focus voltage is the fixed voltage Vf2 of 5 kV to 10 kv superposed with the dynamic voltage dvf of 300 V to 1000 V varying with deflection angle of the electron beams scanning the viewing screen, for example.

Formed between the third electrode 41 of the first focus electrode group and the third electrode 42 of the second focus electrode group is a beam-shaping electrostatic quadrupole lens LA for changing the cross-sectional shape of the electron beams with increase in the dynamic voltage dvf. Formed between the fifth electrode 61 of the first focus electrode group and the fifth electrode 62 of the second focus electrode group is an astigmatism producing electrostatic quadrupole lens LB for elongating the cross-sectional shape of the electron beams vertically increasingly with the increase in the dynamic voltage dvf. That is to say, in this electron gun, the first-stage electrostatic quadrupole lens LA nearer to the cathodes 1 and the second-stage electrostatic quadrupole lens LB nearer to the anode 7 are spaced by a specified distance from each other.

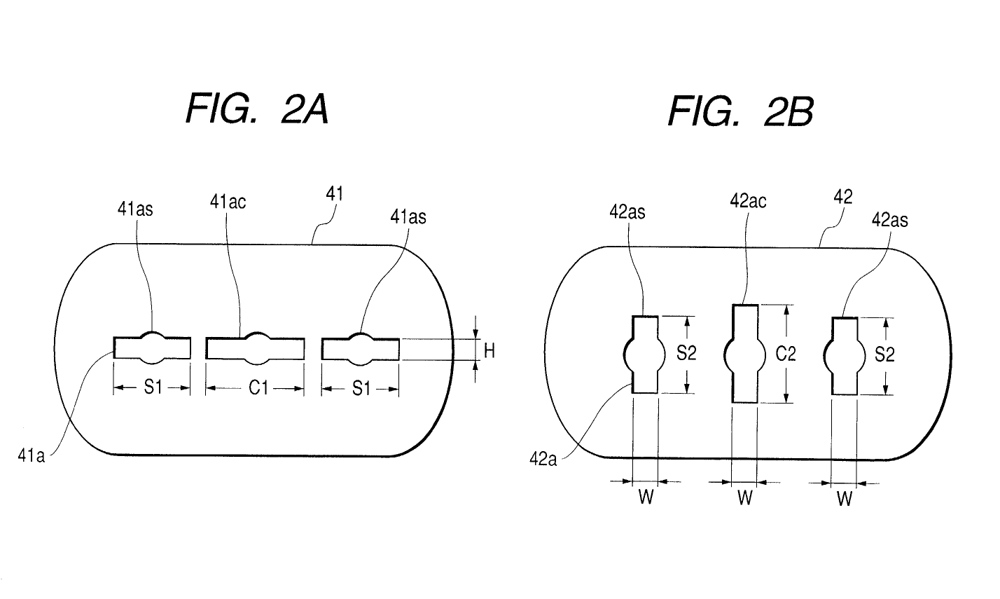

In the electrostatic quadrupole lens LA, opposing surfaces of the third electrode 41 of the first focus electrode group and the third electrode 42 of the second focus electrode group are formed with horizontally elongated keyhole beam apertures 41a and vertically elongated keyhole beam apertures 42a, respectively, as described subsequently in greater detail in connection with FIGS. 2A and 2B. Formed between the third electrode 41 of the first focus electrode group and the third electrode 42 of the second focus electrode group is the electron beam-shaping electrostatic quadrupole lens LA which serves to elongate horizontally the cross-sectional shape of the electron beams with increase in the dynamic voltage dVf. Further, the horizontally elongated keyhole beam apertures formed in the third electrode 41 of the first focus electrode group are configured such that the ratio of the vertical diameter to the horizontal diameter of a rectangular portion of the center beam aperture is smaller than that of a rectangular portion of the respective side beam apertures, and the vertically elongated keyhole beam apertures formed in the third electrode 42 of the second focus electrode group are configured such that the ratio of the vertical diameter to the horizontal diameter of a rectangular portion of the center beam aperture is greater than that of a rectangular portion of the respective side beam apertures, so that the lens strength for the respective side beams is made weaker than that for the center beam.

FIGS. 2A and 2B are plan views of major portions of the third electrode 41 of the first focus electrode group and the third electrode 42 of the second focus electrode group show in FIG. 1, respectively. FIG. 2A is an illustration of the electron beam apertures 41a formed in an end of the third electrode 41 of the first focus electrode group facing the third electrode 42 of the second focus electrode group, and FIG. 2B is an illustration of the electron beam apertures 42a formed in an end of the third electrode 42 of the second focus electrode group facing the third electrode 41 of the first focus electrode group.

In FIG. 2A, the three electron beam apertures 41a in the third electrode 41 of the first focus electrode group are made in the form of the horizontally elongated keyhole having a vertical diameter H. The horizontal diameter C1 of a rectangular portion of the center electron beam aperture 41ac of the three electron beam apertures 41a is made larger than the horizontal diameter S1 of a rectangular portion of the side electron beam apertures 41as so that the ratio H/C1 of the vertical diameter to the horizontal diameter of the rectangular portion of the center electron beam aperture 41ac is made smaller than the ratio H/S1 of the vertical diameter to the horizontal diameter of the rectangular portion of the side electron beam apertures 41as, and thereby the lens strength of the electrostatic quadrupole lens for the side beams is made weaker than that of the electrostatic quadrupole lens for the center beam.

In FIG. 2B, the three electron beam apertures 42a in the third electrode 42 of the second focus electrode group are made in the form of the vertically elongated keyhole having a horizontal diameter W. The vertical diameter C2 of a rectangular portion of the center electron beam aperture 42ac of the three electron beam apertures 42a is made larger than the vertical diameter S2 of a rectangular portion of the side electron beam apertures 42as so that the ratio C2/W of the vertical diameter to the horizontal diameter of the rectangular portion of the center electron beam aperture 42ac is made greater than the ratio S2/W of the vertical diameter to the horizontal diameter of the rectangular portion of the side electron beam apertures 42as, and thereby the lens strength of the electrostatic quadrupole lens for the side beams is made weaker than that of the electrostatic quadrupole lens for the center beam in this third electrode 42 also.

In the above embodiment, the following two configurations are employed:

(1) the ratio H/C1 of the vertical diameter to the horizontal diameter of the rectangular portion of the center electron beam aperture 41ac is made smaller than the ratio H/S1 of the vertical diameter to the horizontal diameter of the rectangular portion of the side electron beam apertures 41as in the third electrode 41 of the first focus electrode group, and

(2) the ratio C2/W of the vertical diameter to the horizontal diameter of the rectangular portion of the center electron beam aperture 42ac is made greater than the ratio S2/W of the vertical diameter to the horizontal diameter of the rectangular portion of the side electron beam apertures 42as in the third electrode 42 of the second focus electrode group.

However, the advantages similar to those obtained by the above embodiment can be provided even if only one of the above two configurations are employed.

The second-stage electrostatic quadrupole lens LB is formed by a combination of four protuberant vertical correction plates 611 attached to the fifth electrode 61 of the first focus electrode group and two protuberant horizontal correction plates 621 attached to the fifth electrode 62 of the second focus electrode group. The four protuberant vertical correction plates 611 protrude axially from the fifth electrode 61 toward the fifth electrode 62 of the second focus electrode group, and are arranged at equal intervals in a direction of an in-line arrangement of the three electron beams so as to shield the three adjacent electron beams from each other. The two protuberant horizontal correction plates 62 protrude axially from the fifth electrode 62 toward the fifth electrode 61 and are arranged approximately in parallel with the direction of travel of the electron beams so as to sandwich the three electron beams vertically.

In this embodiment, the beam-shaping electrostatic quadrupole lens LA reduces the amount of correction for the R beam, one of the two side electron beams, deflected to the left-hand side of the viewing screen and the amount of correction for the B beam, the other of the two side electron beams, deflected to the right-hand side of the viewing screen, and consequently, deterioration in resolution due to excessive increase in vertical diameters of the beam spots can be suppressed.

On the other hand, the diameters of the beam spot formed by the R beam deflected to the right-hand side of the screen and the beam spot formed by the B beam deflected to the left-hand side of the screen are elongated horizontally more than those of the beam spots formed by the G beam which is the center electron beam, the R beam deflected to the left-hand side of the screen, and the B beam deflected to the right-hand side of the screen because the R beam deflected to the right-hand side of the screen and the B beam deflected to the left-hand side of the screen are strongly influenced by the self-converging magnetic fields of the deflection yoke. Further, the beam-shaping electrostatic quadrupole lens LA of the above configuration provides weaker lens action on the R and B beams than on the G beam, therefore the R and B beams are not shaped as much as the G beam, and as a result the beam spots of the R beam deflected to the right-hand side of the screen and the B beam deflected to the left-hand side of the screen are elongated horizontally after shaping by the beam-shaping electrostatic quadrupole lens LA.

Generally, considering the proportion of brightness produced by the G beam in a white scene, the brightness by the G beam account for 70% to 80%. The G beam is dominant in occurrence of moire, and consequently, even if the amount of correction of elongation of the R and B beam spots due to the self-converging magnetic fields of the deflection yoke is smaller than that of the G beam, substantial deterioration in resolution is not caused by moire.

Resolution in a single color by the R or B beam is of practical importance among characteristics of a color cathode ray tube, and vertical resolution is important especially for displaying characters on the viewing screen. Therefore characteristics of the color cathode ray tube are not degraded by horizontal elongation of the spots of the R beam at the right-hand side of the screen and the B beam at the left-hand side of the screen which is produced by making the lens strength of the beam-shaping electrostatic quadrupole lens LA for the R and B beams weaker than that for the G beam.

As explained above, deterioration in resolution by the R and B beams due to the self-converging magnetic fields of the deflection yoke is suppressed by making the lens strength of the beam-shaping electrostatic quadrupole lens LA for the R and B beams, the two side beams, weaker than that for the G beam, the center beam, and thereby realized are the G beam spot uniform over the entire screen area, reduction of moire, and improvement of resolution by the R and B beams.

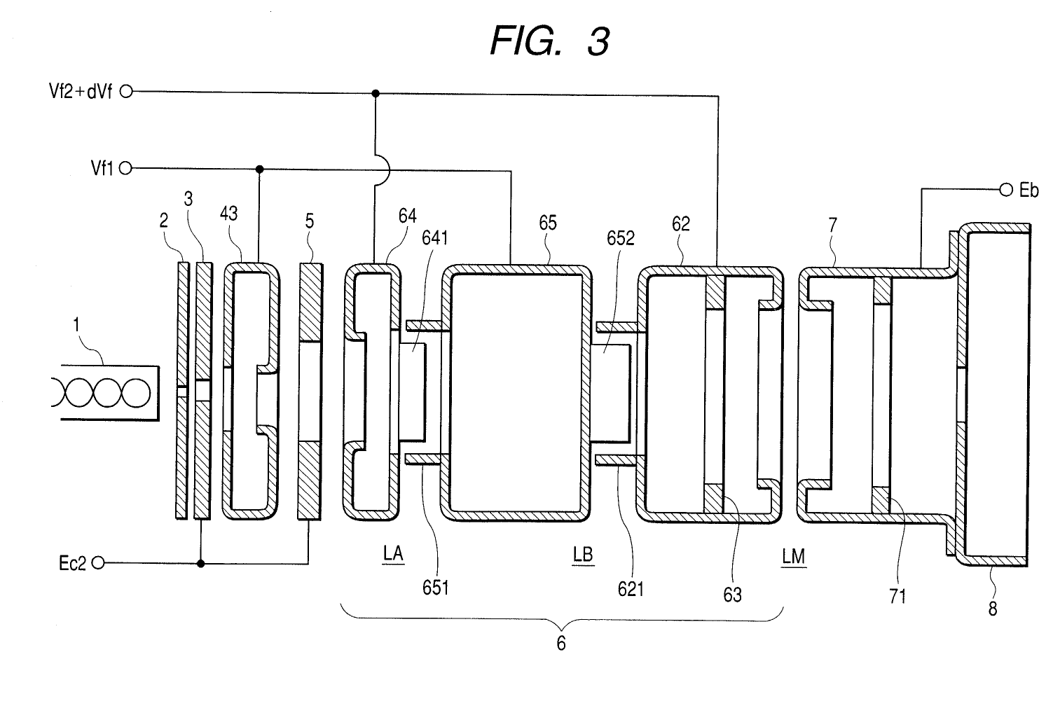

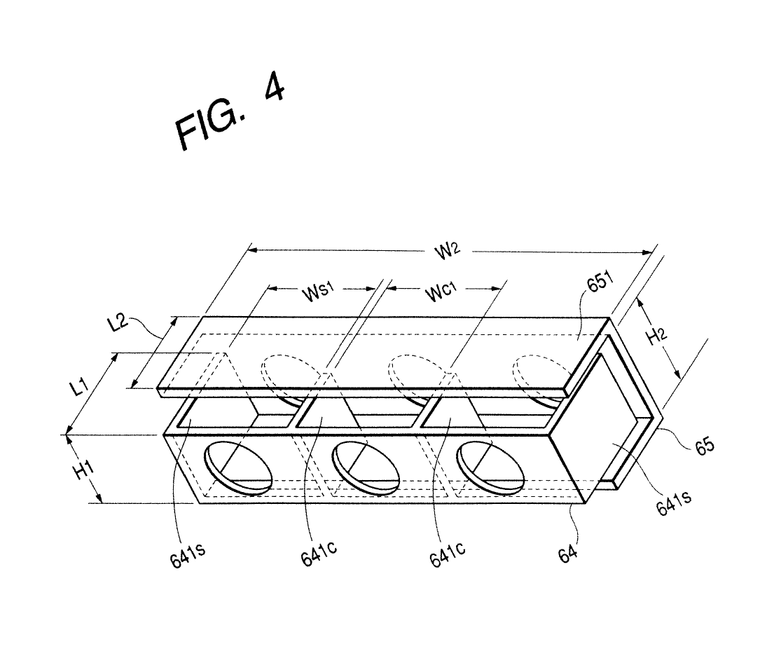

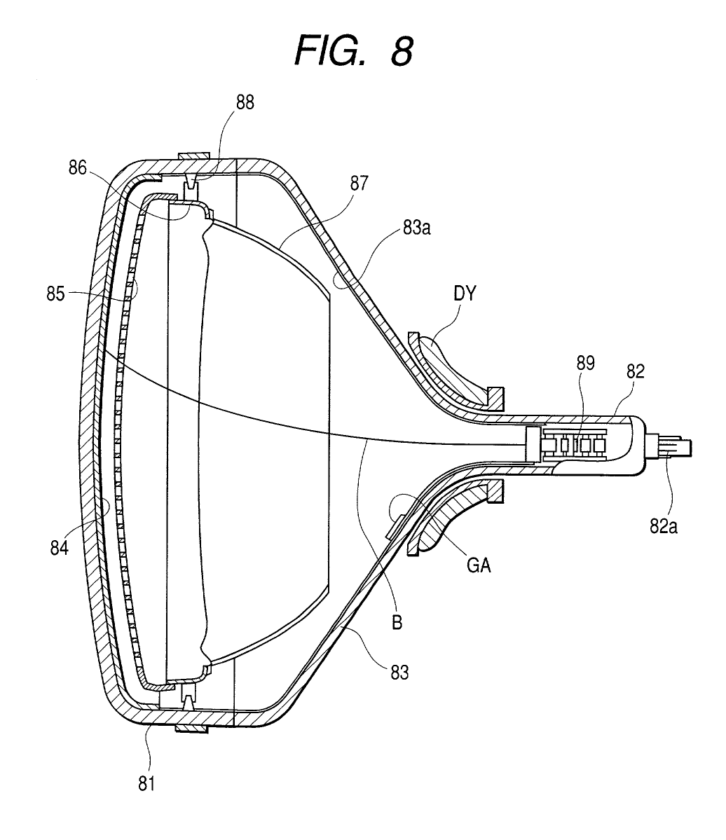

FIG. 3 is a schematic cross-sectional view of an electron gun for explaining a color cathode ray tube in accordance with another embodiment of the present invention, viewed in a direction of an in-line arrangement of the three electron beams. The same reference numerals as utilized in FIGS. 1, 2, 8 and 9 designate functionally similar portions in FIG. 3.

In the embodiment shown in FIG. 3, the fifth electrode 6 is formed of the fifth electrode 65 of the first focus electrode group, and the fifth electrodes 62 and 64 of the second focus electrode group with the fifth electrode 65 interposed therebetween.

The first-stage electrostatic quadrupole lens LA for beam shaping is formed by four protuberant vertical correction plates 641 attached to the fifth electrode 64 of the second focus electrode group and two protuberant horizontal correction plates 651 attached to the fifth electrode 65 of the first focus electrode group. The four protuberant vertical correction plates 641 protrude axially from the fifth electrode 64 toward the fifth electrode 65 of the first focus electrode group, and are arranged at specified intervals in a direction of an in-line arrangement of the three electron beams so as to shield the three adjacent electron beams from each other. The two protuberant horizontal correction plates 651 protrudes axially from the fifth electrode 65 toward the fifth electrode 64 and are arranged approximately in parallel with the direction of travel of the electron beams so as to sandwich the three electron beams vertically. The configurations of the protuberant vertical correction plates 641 and the protuberant horizontal correction plates 651 will be shown in FIG. 4 described subsequently.

The second-stage electrostatic quadrupole lens LB is formed by four protuberant vertical correction plates 652 attached to the fifth electrode 65 of the first focus electrode group and two protuberant horizontal correction plates 621 attached to the fifth electrode 62 of the second focus electrode group. The four protuberant vertical correction plates 652 protrude axially from the fifth electrode 65 toward the fifth electrode 62 of the second focus electrode group, and are arranged at equal intervals in a direction of an in-line arrangement of the three electron beams so as to shield the three adjacent electron beams from each other. The two protuberant horizontal correction plates 621 protrude axially from the fifth electrode 62 toward the fifth electrode 65 and are arranged approximately in parallel with the direction of travel of the electron beams so as to sandwich the three electron beams vertically. The configurations of the protuberant vertical correction plates 641 and the protuberant horizontal correction plates 651 will be shown in FIG. 4 described subsequently.

The accelerating electrode 3 and the fourth electrode 5 are supplied with a fixed voltage Ec2 of about 400V to about 1000V, and the third electrode 43 and the fifth electrode 65 of the first focus electrode group are supplied with a first focus voltage of a fixed value Vf1. The fifth electrode 64 and the fifth electrode 62 of the second focus electrode group are supplied with a second focus voltage (Vf2+dVf) which is a fixed voltage Vf2 superposed with a dynamic voltage dvf varying with deflection angle of the electron beams scanning the viewing screen. The first focus voltage is the fixed voltage Vf1 in a range of 5 kV to 10 kV, for example, and the second focus voltage is the fixed voltage Vf2 of 5 kV to 10 kV superposed with the dynamic voltage dVf of 300 V to 1000 V varying with deflection angle of the electron beams scanning the viewing screen, for example.

FIG. 4 is a perspective view of major portions of the first-stage electrostatic quadrupole lens LA formed by the fifth electrode 65 of the first focus electrode group and the fifth electrode 64 of the second focus electrode group shown in FIG. 3. In FIG. 4, the four protuberant vertical correction plates 641 attached to the fifth electrode 64 comprise a pair of inner protuberant vertical correction plates 641c sandwiching the center electron beam path horizontally and a pair of outer protuberant vertical correction plates 641s located outside the respective side beam paths in parallel with the inner protuberant vertical correction plates 641c. The spacing WS1 between the outer protuberant vertical correction plates 641s and the adjacent inner protuberant vertical correction plates 641c is selected to be greater than the spacing WC1 between the two inner protuberant vertical correction plates 641c. The axial length L1 and the height H1 are selected to be identical for all the four protuberant vertical correction plates 641, in this embodiment. The fifth electrode 65 of the first focus electrode group facing the fifth electrode 64 is provided with two protuberant horizontal correction plates 651 protruding toward the fifth electrode 64 sandwiching the three electron beams vertically. The axial length L2 of the two protuberant horizontal correction plates 651 and the spacing H2 between the two protuberant horizontal correction plates 651 are selected to be greater than the axial length L1 and the height H1 of the four protuberant vertical correction plates 641, respectively, and the width W2 of the protuberant horizontal correction plates 651 is selected to be so sufficient as to surround the three electron beam paths in cooperation with the four protuberant vertical correction plates 641.

On the other hand, the second-stage electrostatic quadrupole lens LB is formed by four protuberant vertical correction plates 652 attached to the fifth electrode 65 and two protuberant horizontal correction plates 621 attached to the fifth electrode 62 facing the fifth electrode 65. The four protuberant vertical correction plates 652 are of the same axial length and the height and are arranged at equal intervals, and the two protuberant horizontal correction plates 621 are of the same axial length and the same width.

In this embodiment, the first-stage electrostatic quadrupole lens LA for beam-shaping is capable of making its lens strength for the side electron beams weaker than its lens strength for the center electron beam, and provides good and uniform focus over the entire viewing screen area as in the case of the first embodiment described previously.

In the embodiment explained in connection with FIG. 4 the four protuberant vertical correction plates 641 are of the same axial length L1 and the height H1, but if the height and the axial length of the outer protuberant vertical correction plates 641s are selected to be smaller than the height and the axial length of the inner protuberant vertical correction plates 641c, respectively, and at the same time the spacing WS1 is selected to be greater than the spacing WC1 as in the embodiment shown in FIG. 4, the lens strength of the electrostatic quadrupole lens for the side electron beams can be made even weaker than that for the center electron beam.

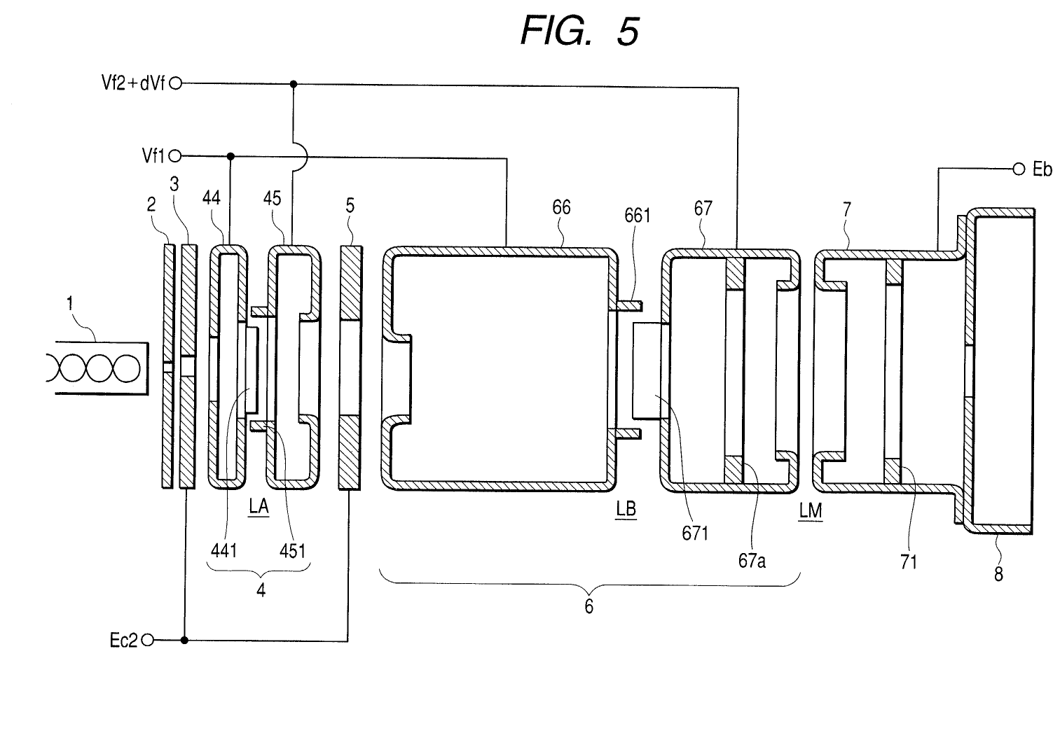

FIG. 5 is a schematic cross-sectional view of an electron gun for explaining a color cathode ray tube in accordance with still another embodiment of the present invention viewed in the direction of the in-line arrangement of the three electron beams. The same reference numerals as utilized in FIGS. 1-4, 8 and 9 designate functionally similar portions in 5.

In the embodiment shown in FIG. 5, the first-stage electrostatic quadrupole lens LA for beam shaping is formed by four protuberant vertical correction plates 441 attached to the third electrode 44 of the first focus electrode group and the two protuberant horizontal correction plates 451 attached to the third electrode 45 of the second focus electrode group facing the third electrode 44. The four protuberant vertical correction plates 441 protrude axially from the third electrode 44 toward the third electrode 45 of the second focus electrode group, and are arranged at specified intervals in the direction of the in-line arrangement of the three electron beams so as to shield the three adjacent electron beams from each other. The two protuberant horizontal correction plates 451 protrude axially from the third electrode 45 toward the third electrode 44 and are arranged approximately in parallel with the direction of travel of the electron beams so as to sandwich the three electron beams vertically. The spacing between the two adjacent protuberant vertical correction plates 441 on opposite sides of the side electron beam path is selected to be greater than the spacing between the two adjacent protuberant vertical correction plates 441 on opposite sides of the center electron beam path so that the lens strength of the electrostatic quadrupole lens for the side electron beams is made weaker than that for the center electron beam.

The second-stage electrostatic quadrupole lens LB is formed by four protuberant vertical correction plates 671 attached to the fifth electrode 67 of the second focus electrode group and two protuberant horizontal correction plates 661 attached to the fifth electrode 66 of the first focus electrode group facing the fifth electrode 67. The four protuberant vertical correction plates 671 protrude axially from the fifth electrode 67 toward the fifth electrode 66 of the first focus electrode group, and are arranged at equal intervals in the direction of the in-line arrangement of the three electron beams so as to shield the three adjacent electron beams from each other. The two protuberant horizontal correction plates 661 protrude axially from the fifth electrode 66 toward the fifth electrode 67 and are arranged approximately in parallel with the direction of travel of the electron beams so as to sandwich the three electron beams vertically. Reference numeral 67a denotes a correction plate electrode disposed within the fifth electrode 67.

The accelerating electrode 3 and the fourth electrode 5 are supplied with a fixed voltage Ec2 of about 400V to about 1000V, and the third electrode 44 and the fifth electrode 66 of the first focus electrode group are supplied with a first focus voltage of a fixed value Vf1. The third electrode 45 and the fifth electrode 67 of the second focus electrode group are supplied with a second focus voltage (Vf2+dVf) which is a fixed voltage Vf2 superposed with a dynamic voltage dvf varying with deflection angle of the electron beams scanning the viewing screen. The first focus voltage is the fixed voltage Vf1 in a range of 5 kV to 10 kV, for example, and the second focus voltage is the fixed voltage Vf2 of 5 kV to 10 kV superposed with the dynamic voltage dvf of 300 V to 1000 V varying with deflection angle of the electron beams scanning the viewing screen, for example.

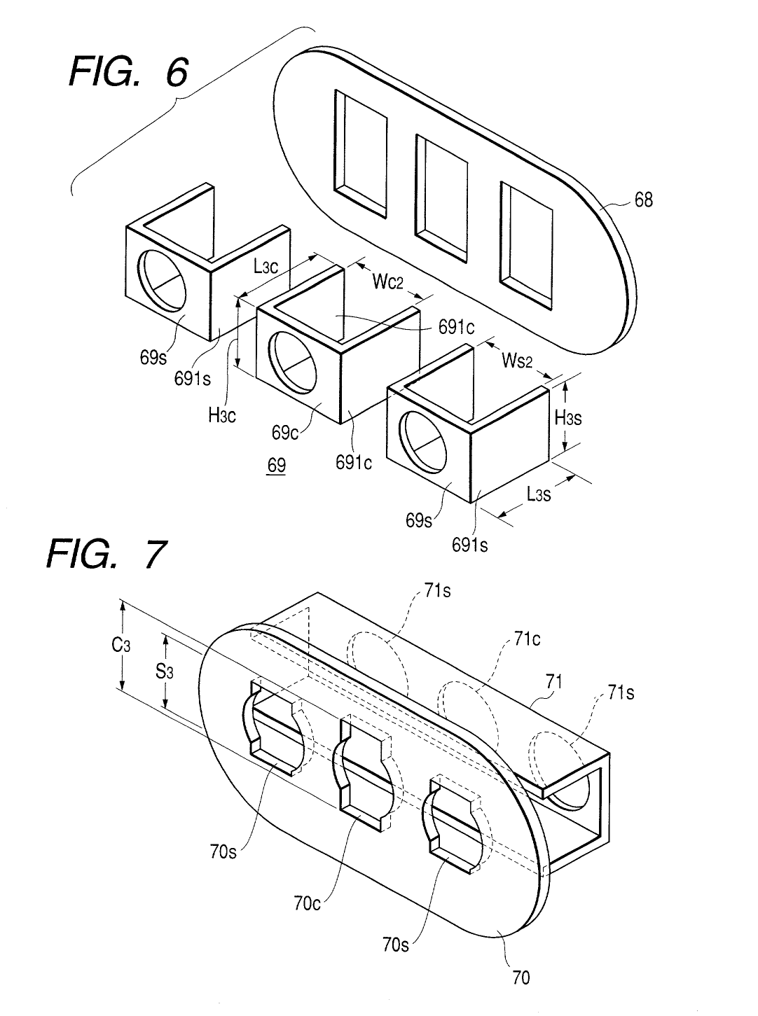

FIG. 6 is a perspective view similar to that of FIG. 4, illustrating major portions of focus electrodes for explaining a color cathode ray tube in accordance with still another embodiment of the present invention.

In the embodiment shown in FIG. 6, the first-stage electrostatic quadrupole lens LA for beam shaping is formed by a focus electrode 68 in the form of a plate and a focus electrode 69 comprised of three U-shaped electrodes. The focus electrode 69 is formed of a generally U-shaped electrode 69c associated with the center electron beam and two generally U-shaped electrodes 69s associated with the two side electron beams, and the following relationships are satisfied:

Wc2<Ws2, H3c>H3s, and L3c>L3s,

where Wc2=a spacing between two protuberant vertical correction plates 691c of the electrode 69c associated with the center electron beam,

H3c=a height of the protuberant vertical correction plates 691c,

L3c=an axial length of the protuberant vertical correction plates 691c,

Ws2=a spacing between two protuberant vertical correction plates 691s of the electrode 69s associated with the side electron beams,

H3s=a height of the protuberant vertical correction plates 691s,

L3s=an axial length of the protuberant vertical correction plates 691s.

FIG. 7 is a perspective view similar to that of FIG. 4, illustrating major portions of focus electrodes for explaining a color cathode ray tube in accordance with still another embodiment of the present invention.

In the embodiment shown in FIG. 7, the first-stage electrostatic quadrupole lens LA for beam shaping is formed by a focus electrode 70 in the form of a plate and a generally U-shaped focus electrode 71. The focus electrode 70 is formed with vertically elongated keyhole beam apertures 70c and 70s, and the vertical diameter c3 of the center beam aperture 70c is selected to be larger than the vertical diameter s3 of the side beam apertures 70s. The generally U-shaped focus electrode 71 facing the focus electrode 70 is formed with three circular beam apertures 71c, 71s of the same diameter.

In this embodiment, the lens strength of the electrostatic quadrupole lens for the side electron beams is be made weaker than that for the center electron beam by making the vertical diameter c3 of the center beam aperture 70c larger than the vertical diameter s3 of the side beam apertures 70s. As explained above, with the representative configurations of the present invention, by making the lens strength of the beam-shaping electrostatic quadrupole lens of the electron gun for the side electron beams weaker than that for the center electron beam, there is provided a cathode ray tube superior in resolution characteristics which has suppressed deterioration in resolution of the side electron beams caused by self-converging magnetic fields of the deflection yoke and thereby provides good focus in a wide area of the viewing screen and suppressed occurrence of moire.

What is claimed is:

1. A color cathode ray tube comprising an evacuated envelope comprising a panel portion, a neck portion and a funnel portion for connecting said panel portion and said neck portion, a phosphor screen formed on an inner surface of said panel portion, an in-line type electron gun housed in said neck portion, and an electron beam deflection yoke mounted around a vicinity of a transitional region between said neck portion and said funnel portion,
said in-line type electron gun comprising:
an electron beam generating section having three in-line cathodes, a first electrode serving as an electron beam control electrode and a second electrode serving as an accelerating electrode arranged in the order named for projecting three electron beams arranged approximately in parallel with each other in a horizontal plane toward said phosphor screen;
a first group of focus electrodes supplied with a first focus voltage of a fixed value;
a second group of focus electrodes supplied with a second focus voltage comprised of a fixed voltage and a dynamic voltage varying in synchronism with deflection of said three electron beams;
an anode forming a main lens in cooperation with an adjacent one of said second group of focus electrodes; and
a plurality of axially spaced electrostatic quadrupole lenses being formed between facing ones of said first and second groups of focus electrodes such that each of said plurality of electrostatic quadrupole lenses increases a lens strength thereof for focusing said three electron beams in one of horizontal and vertical directions, and increases a lens strength thereof for diffusing said three electron beams in another of the horizontal and vertical directions, with an increase in a focus voltage difference between said first focus voltage and said second focus voltage,
wherein a first one of said plurality of electrostatic quadrupole lenses disposed nearest to said three in-line cathodes is configured so as to produce a lens action weaker on two side electron beams of said three electron beams than on a center electron beam of said three electron beams.

2. A color cathode ray tube according to claim 1, wherein
said first one of said plurality of electrostatic quadrupole lenses increases a lens strength thereof for focusing said three electron beams in one of horizontal and vertical directions, and increases a lens strength thereof for diffusing said three electron beams in another of the horizontal and vertical directions, with an increase in a focus voltage difference between said first focus voltage and said second focus voltage, and
a second one of said plurality of electrostatic quadrupole lenses located downstream from said first one of said plurality of electrostatic quadrupole lenses increases a lens strength thereof for focusing said three electron beams in said another of horizontal and vertical directions, and increases a lens strength thereof for diffusing said three electron beams in said one of the horizontal and vertical directions, with the increase in the focus voltage difference.

3. A color cathode ray tube according to claim 1, wherein
said first one of said plurality of electrostatic quadrupole lenses comprises a center lens for said center electron beam and two side lenses for said two electron beams,
each of said center lens and said two side lenses is formed between a respective one of three vertically elongated apertures formed in one of said facing ones of said first and second groups of focus electrodes and a corresponding one of three horizontally elongated apertures formed in another of said facing ones of said first and second groups of focus electrodes, and
ratios of a vertical diameter to a horizontal diameter of generally rectangular portions of said vertically and horizontally elongated apertures for said center electron beam satisfy at least one of the following condition:
(i) the ratio of said vertically elongated aperture for said center electron beam is greater than a ratio of a vertical diameter to a horizontal diameter of respective generally rectangular portions of said vertically elongated apertures for said two side electron beams, and
(ii) the ratio of said horizontally elongated aperture for said center electron beam is smaller than a ratio of a vertical diameter to a horizontal diameter of respective generally rectangular portions of said horizontally elongated apertures for said two side electron beams.

4. A color cathode ray tube according to claim 1, wherein
said first one of said plurality of electrostatic quadrupole lenses comprises a center lens for said center electron beam and two side lenses for said two electron beams,
at least one of said facing ones of said first and second groups of focus electrodes forming said first one of said plurality of electrostatic quadrupole lenses is formed with one of (i) three vertically elongated apertures and (ii) three horizontally elongated apertures, and
a ratio of a vertical diameter to a horizontal diameter of a generally rectangular portion of said center electron beam satisfies one of the following condition:
(iii) when said at least one of said facing ones of said first and second groups of focus electrodes forming said first one of said plurality of electrostatic quadrupole lenses is formed with said three vertically elongated apertures, the ratio of said vertically elongated aperture for said center electron beam is greater than a ratio of a vertical diameter to a horizontal diameter of respective generally rectangular portions of said vertically elongated apertures for said two side electron beams, and
(iv) when said at least one of said facing ones of said first and second groups of focus electrodes forming said first one of said plurality of electrostatic quadrupole lenses is formed with said three horizontally elongated apertures, the ratio of said horizontally elongated aperture for said center electron beam is smaller than a ratio of a vertical diameter to a horizontal diameter of respective generally rectangular portions of said horizontally elongated apertures for said two side electron beams.

5. A color cathode ray tube according to claim 1, wherein
said first one of said plurality of electrostatic quadrupole lenses comprises a center lens for said center electron beam and two side lenses for said two electron beams,
each of said center lens and said two side lenses is formed by plates attached to at least one of said facing ones of said first and second groups of focus electrodes so as to sandwich a respective one of said three electron beams therebetween, and
a spacing between said plates forming each of said two side lenses is greater than a spacing between said plates forming said center lens in at least one of horizontal and vertical directions.

6. A color cathode ray tube according to claim 2, wherein
said first one of said plurality of electrostatic quadrupole lenses comprises a center lens for said center electron beam and two side lenses for said two electron beams,
each of said center lens and said two side lenses is formed between a respective one of three vertically elongated apertures formed in one of said facing ones of said first and second groups of focus electrodes and a corresponding one of three horizontally elongated apertures formed in another of said facing ones of said first and second groups of focus electrodes, and
ratios of a vertical diameter to a horizontal diameter of generally rectangular portions of said vertically and horizontally elongated apertures for said center electron beam satisfy at least one of the following condition:
(i) the ratio of said vertically elongated aperture for said center electron beam is greater than a ratio of a vertical diameter to a horizontal diameter of respective generally rectangular portions of said vertically elongated apertures for said two side electron beams, and
(ii) the ratio of said horizontally elongated aperture for said center electron beam is smaller than a ratio of a vertical diameter to a horizontal diameter of respective generally rectangular portions of said horizontally elongated apertures for said two side electron beams.

7. A color cathode ray tube according to claim 2, wherein
said first one of said plurality of electrostatic quadrupole lenses comprises a center lens for said center electron beam and two side lenses for said two electron beams,
at least one of said facing ones of said first and second groups of focus electrodes forming said first one of said plurality of electrostatic quadrupole lenses is formed with one of (i) three vertically elongated apertures and (ii) three horizontally elongated apertures, and
a ratio of a vertical diameter to a horizontal diameter of a generally rectangular portion of said center electron beam satisfies one of the following condition:
(iii) when said at least one of said facing ones of said first and second groups of focus electrodes forming said first one of said plurality of electrostatic quadrupole lenses is formed with said three vertically elongated apertures, the ratio of said vertically elongated aperture for said center electron beam is greater than a ratio of a vertical diameter to a horizontal diameter of respective generally rectangular portions of said vertically elongated apertures for said two side electron beams, and
(iv) when said at least one of said facing ones of said first and second groups of focus electrodes forming said first one of said plurality of electrostatic quadrupole lenses is formed with said three horizontally elongated apertures, the ratio of said horizontally elongated aperture for said center electron beam is smaller than a ratio of a vertical diameter to a horizontal diameter of respective generally rectangular portions of said horizontally elongated apertures for said two side electron beams.

8. A color cathode ray tube according to claim 2, wherein
said first one of said plurality of electrostatic quadrupole lenses comprises a center lens for said center electron beam and two side lenses for said two electron beams,
each of said center lens and said two side lenses is formed by plates attached to at least one of said facing ones of said first and second groups of focus electrodes so as to sandwich a respective one of said three electron beams therebetween, and
a spacing between said plates forming each of said two side lenses is greater than a spacing between said plates forming said center lens in at least one of horizontal and vertical directions.
